(19) United States
(12) Patent Application Publication
(10) Pub. No.: US 2011/0127688 A1
(43) Pub. Date: Jun. 2, 2011

(54) METHOD FOR MANUFACTURING MOLDED FOAM

(75) Inventors: Masaaki Onodera, Kanagawa (JP); Takehiko Sumi, Kanagawa (JP); Teruo Tamada, Kanagawa (JP); Yu Igarashi, Kanagawa (JP); Yoshinori Ohno, Kanagawa (JP)

(73) Assignee: Kyoraku Co., Ltd., Kyoto-shi (JP)

(21) Appl. No.: 12/956,698

(22) Filed: Nov. 30, 2010

(30) Foreign Application Priority Data
Nov. 30, 2009 (JP) 2009-272897

(51) Int. Cl. C08J 9/06

(52) U.S. Cl. 264/54

(57) ABSTRACT

A method for manufacturing molded foam which uses cheap materials, is light in weight and which is excellent in impact resistance. In the method for manufacturing molded foam, propylene homopolymer with a long chain branch, propylene ethylene block copolymer and low density polyethylene are mixed in the base resin at a prescribed mixing ratio. A blowing agent is added to carry outfoaming. A prescribed mixing ratio is determined based on the value arrived at by a multiplying melt tension of each material mixed with the melt flow rate and the Tensile Rupture Elongation.

### FIELD OF THE INVENTION

This invention is concerning a method for manufacturing molded foam used in a light weight air conditioner duct for vehicles.

### BACKGROUND AND SUMMARY OF THE INVENTION

An air-conditioner duct for vehicles to ventilate the air-conditioner air supplied by the air-conditioner unit to the desired part is known.

Since light-weight and insulation are essential in such an air-conditioner duct, normally foamed resin molding is used.

It is possible to improve the functionalities of such an air-conditioner duct by adjusting the foamed state.

For instance, in order to provide the duct with sound absorption or noise deadening effect, hollow molding whose inner surface is de-foamed (Refer to Patent Document 1), duct with specified surface hardness and bubble deformation ratio (Refer to Patent Document 2), Foam duct with specific surface roughness to prevent condensation on the outer surface of the air-conditioner duct (Refer to Patent 3), air duct for vehicles having multi-layered structure (Refer to Patent 4) are known.
[Patent Document 1] Published Examined Application No. 08-25230
[Patent Document 2] Patent No. 3997334
[Patent Document 3] Published Unexamined Application No. 2005-241157
[Patent Document 4] Published Unexamined Application No. 2006-205831

However, in the method of manufacturing of conventional air-conditioner duct including air duct mentioned in above mentioned Patent Documents 1-4, in order to secure light weight and high insulation, if the expansion ratio is increased, impact resistance declines.

For instance, in the roof side air-conditioner duct of vehicles, if a curtain air bag to protect the passengers from side shock spreads out based on the force of pressure gas, a roof side air-conditioner duct can break and scatter due to impact at the time of spreading out.

Moreover, simultaneously with using expensive polypropylene for foaming such as polypropylene having long chain branching structure in large quantity, and mixing expensive impact resistant material such as linear low density polyethylene (LLDPE) etc, it is possible to have foammolding that has high expansion ratio and high impact resistance but cost is a problem. Therefore, it is desirable that foammolding that is light in weight and good in impact resistance is made by using cheaper materials.

This invention was carried out in view of above problems and aims at offering method of manufacturing of foammolding that uses cheaper materials, is light in weight and good in impact resistance.

(1) This invention is about the method of manufacturing molded foam
Wherein the base resin containing mixture of propylene homopolymer having long chain branching, propylene ethylene block copolymer and low density polyethylene; blowing agent is mixed to carry out foammolding.
Where value arrived at by multiplying melt tension at 230° C. with melt flow rate at 230° C. is above 30 gf.g/10 minutes
Where aforesaid propylene ethylene block copolymer contains ultrahigh molecular weight polyethylene and the value arrived at by multiplying melt tension at 230° C. with melt flow rate at 230° C. is in the range of 10 (gf·g/10 minutes) and 30 (gf·g/10 minutes).
Where in the aforesaid base resin, weight % of propylene homopolymer having long chain branching, is assumed as W1 (Wt %), weight % of aforesaid propylene ethylene block copolymer is assumed as W2 (Wt %) and weight % of aforesaid low density polyethylene is assumed as W3 (Wt %), it satisfies

20≦W1≦60,10≦W2≦50,30≦W3≦50.
When value of propylene homopolymer having aforesaid long chain branching arrived at by multiplying melt tension at 230° C. with melt flow rate at 230° C. is assumed as M1 (gf·g/10 minutes), value of aforesaid propylene ethylene block copolymer arrived at by multiplying melt tension at 230° C. with melt flow rate is assumed as M2 (gf·g/10 minutes) and the value of aforesaid low density polyethylene arrived at by multiplying melt tension at 230° C. with melt flow rate is assumed as M3 (gf·g/10 minutes), it satisfies

M1×W1/100+M2×W2/100+M3×W3/100≧17.
When Tensile Rupture Elongation at 23° C. of propylene homopolymer having aforesaid long chain branch is assumed as E1(%), Tensile Rupture Elongation at 23° C. of aforesaid propylene ethylene block copolymer is assumed as E2(%) and Tensile Rupture Elongation at 23° C. of aforesaid low density polyethylene is assumed as E3(%), it satisfies E1×W1/100+E2×W2/100+E3×W3/100≧200.

(2) This invention is about the method of manufacturing molded foam mentioned is Claim 1 that satisfies

−0.5×W3+60≦W1≦−0.5×W3+70

(3) This invention is about the method of manufacturing molded foam mentioned under (2) above that satisfies W3≧40.

According to method of manufacturing molded foam mentioned above under (1), it is possible to increase Expansion Ratio and reduce the weight. Further, foammolding that has excellent impact resistance can be formed.

Moreover, since low density polyethylene 30-50 Wt % is mixed, it is possible to form foammolding at low cost.

According to method of manufacturing molded foam mentioned above under (2), foammolding whose Expansion Ratio is more than 2.5 times and impact strength is above 40 kgf-cm can be obtained at low cost.

According to method of manufacturing of foam mentioned above under (3), foam having expansion ratio above 2-5 times and impact strength above 70 Kg. cm can be produced at low cost.

### BRIEF DESCRIPTION OF THE DRAWINGS

FIG. 1 (a) is a Perspective Diagram showing a Roof side duct manufactured based on the exemplary embodiment(s).

FIG. 1) (b) is X-X¹ line View Cross Section diagram of FIG. 1 (a).

FIG. 2 Cross section of the Roof side Duct mentioned in FIG. 1 mounted in a vehicle.

FIG. 3 Cross section showing the state of roof side duct mentioned in FIG. 1 when blow molded.

FIG. 4 Perspective diagram showing AC floor duct manufactured based on the exemplary embodiment(s).

### DETAILED DESCRIPTION OF THE INVENTION

### Exemplary Embodiments

In the following lines, an exemplary embodiment has been explained while referring to Figures as and when required.

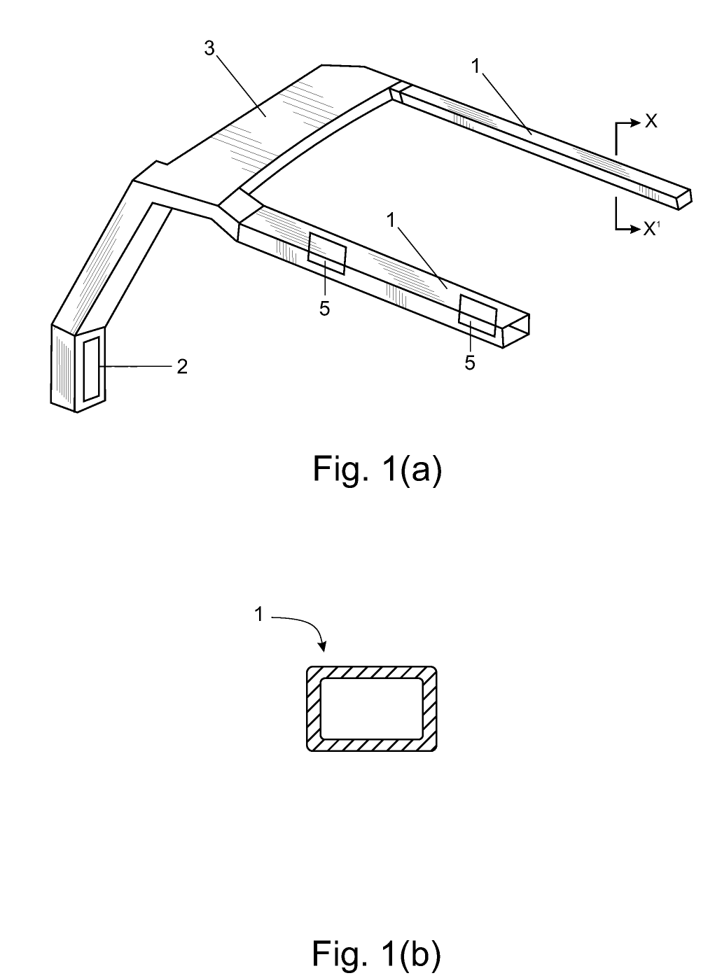

Roof side duct illustrated in FIG. 1(a) is meant for ventilating air-conditioner air supplied by an AC (air conditioning) unit to the desired part.

This Roof side duct has hollow polygonal column-like shape and is integral blow molding. Blow molding will be described later.

Roof side duct 1 is supported by traverse duct 3 on the plane.

On one end of traverse duct 3, air supply port 2 to supply air-conditioner air is equipped and air-conditioner air supplied from this port enters the hollow portion of roof side duct 1 through the inner side of the traverse duct not shown in FIG. 1(a).

This air-conditioner air is discharged from air exhaust port 5 equipped in the Roof side duct 1.

Mean thickness of wall 1a of this Roof side duct 1 is molded in a manner that it is below 3.5 mm. By thinning the thickness of the wall 1a of the roof side duct 1, the flow path of air-conditioner air that flows through inside of roof side duct 1 can be set widely.

Further, mean bubble diameter of bubble cell in the thickness direction of wall 1a should be below 300 μm. It increases the mechanical strength. Mean bubble diameter may further be below 100 μm.

Roof side duct 1 has independent bubble structure having an expansion ratio of above 2.0 times. Here, the expansion ratio is the value arrived at by dividing the density of thermoplastic resin using foam blow molding with the apparent density of wall 1 of foam blow molding. Further, independent bubble structure has multiple bubble cell structure and implies one which has a minimum independent bubble ratio of above 70%.

In case of an expansion ratio is below 2 times, compared to the case when expansion ratio is within the above range, weight reduction becomes insufficient and heat insulation becomes low and condensation can occur.

Roof side duct 1 may have tensile rupture elongation above 40% and possibly above 100%. Here tensile rupture elongation is the value measured in accordance with JIS K-7113.

If tensile rupture elongation at −10° C. is below 40%, there are chances of breakage compared to when tensile rupture elongation is within the above range.

Tensile elasticity modulus of Roof side duct 1 at a normal temperature (23° C.) should preferably be above 1000 Kg/cm² but if it is in the range of 1100-1500 Kg/cm² it is even much better. Here, tensile elasticity modulus is calculated in accordance with JIS K-7113.

If tensile elasticity modulus at the normal temperature is below 1000 Kg/cm², there are chances of the Roof Side Duct getting deformed compared to when it is in the above range.

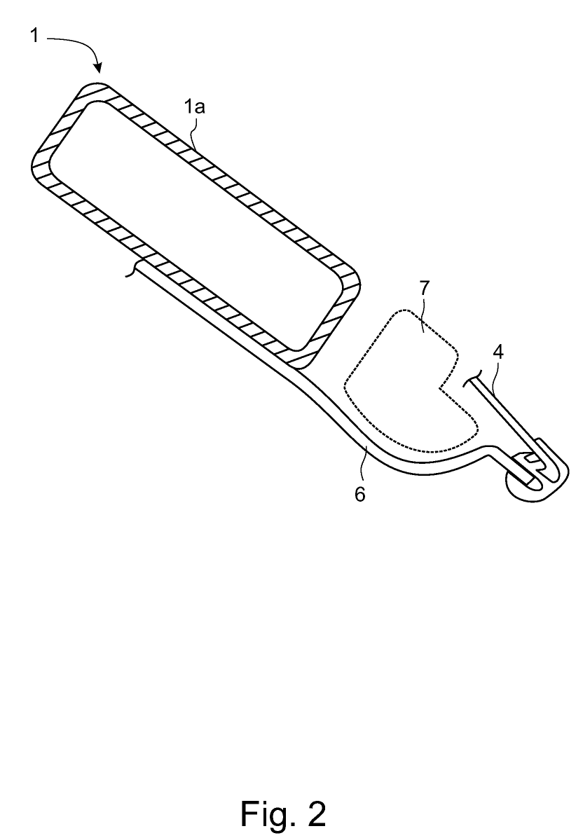

As indicated in FIG. 2, Roof Side Duct 1 is positioned along Curtain Air Bag 7 in-between interior roof 6 and body panel 4.

When Curtain Air Bag 7 gets spread out due to pressure gas, shock due to spreading out of Curtain Air Bag 7 to Roof Side Duct 1 positioned behind Curtain Air Bag 7 can get transferred.

The Roof Side Duct mentioned here is obtained by adding blowing agent to base resin which is a mixture of propylene homopolymer having long chain branching, propylene ethylene block copolymer and low density polyethylene and by carrying out foam blow molding.

Propylene homopolymer having long chain branching used here is one whose value arrived at by multiplying melt tension with melt flow rate at 230° C. is above 30 (gf·f/10 min). For instance, one can use Daploi (WB 130, WB 135) of Borealis Co.

Further, as a Propylene ethylene block copolymer, one which contains ultrahighmolecular weight polyethylene and whose value obtained by multiplying melt tension at 230° C. with melt flow rate is in the range of 10 (gf·g/10 minutes) and 30 (gf·g/10 minutes).

For instance, New Foamer (FB 3312) of Japan Polypropylene Corporation can be used.

“Sumikasen” (F108-1) of Sumitomo Chemicals can be used as a low density polyethylene. Further, the low density polyethylene is the polymer where the ethylene skeleton is polymerized as a repeating unit and has many branched chains. Low density polyethylene is obtained by polymerizing polyethylene at high pressure of 1000-3500 atmospheric pressure. The low density polyethylene density is in the range of 910 Kg/m³ and 930 Kg/m³.

Inorganic blowing agents such as air, carbon dioxide gas, nitrogen gas, water etc. and organic blowing agents such as butane, pentane, hexane, dichloromethane, dichloro ethane etc. can be used as blowing agent.

Use of the super critical fluid may be used as the foaming method. To be more precise, carbonate gas or nitrogen gas in super critical state may be used for foaming the base resin. In such a case, foaming can be carried out uniformly and definitely.

Further, in case the supercritical gas is nitrogen, critical temp should be −149.1° C. and critical pressure above 3.4 MPa and in case, the super critical gas is carbon dioxide, critical temperature should be 31° C. and critical pressure above 7.4 MPa.

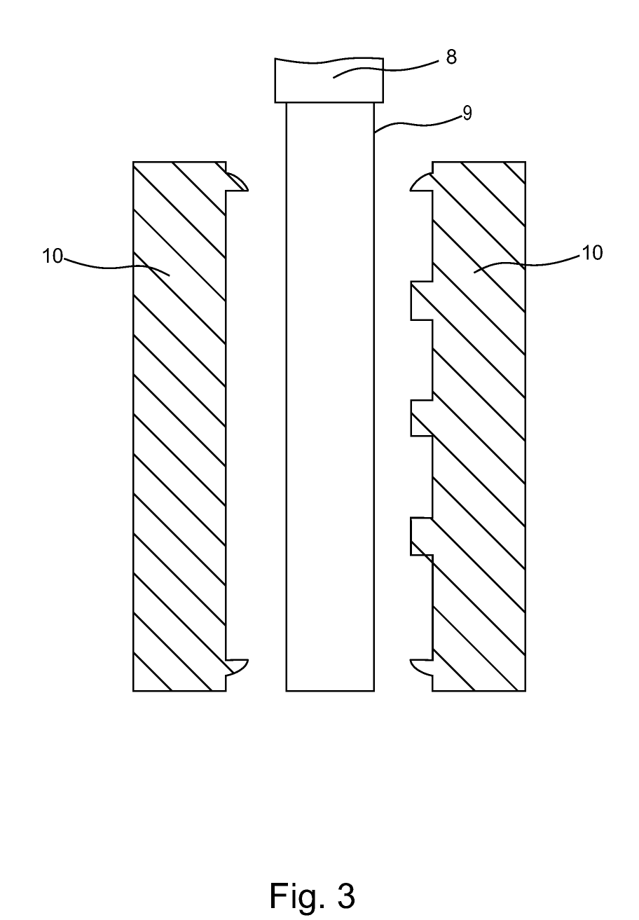

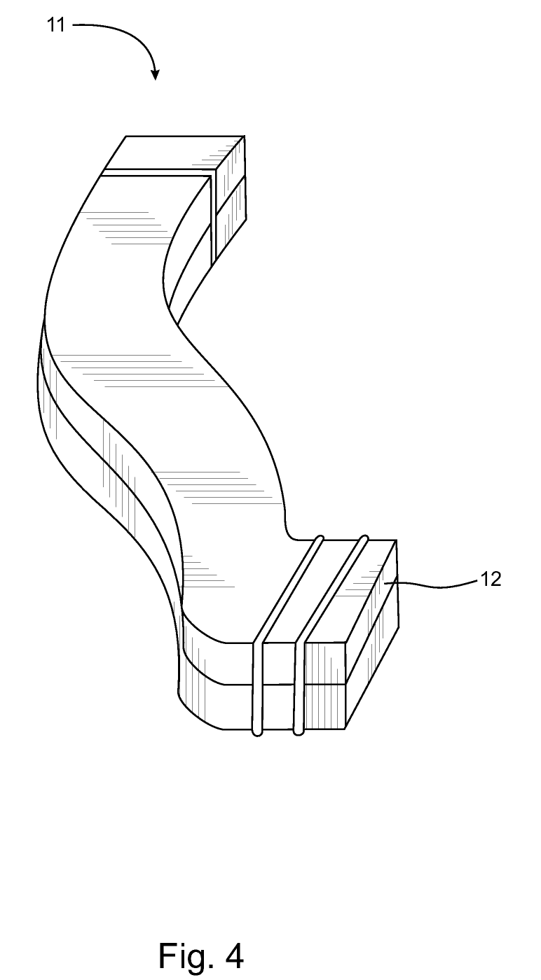

FIG. 3 is the cross section of the state of Roof Side Duct when blow molded.

First, prepare the base resin by mixing propylene homopolymer having long chain branching, propylene ethylene block polymer and low density polyethylene at the prescribed ratio in the extruder.

At this time, if weight % of propylene homopolymer having long chain branching is assumed as W1 (Wt %), weight % of propylene ethylene block copolymer is assumed as W2 (Wt %) and weight % of low density polyethylene is assumed as W3 (Wt %), in base resin, above mentioned W1, W2, W3 are determined so as to satisfy the below mentioned Eq. 1.

20≦W1≦60,10≦W2≦50,30≦W3≦50 [Eq. 1]

Further, when value of propylene homopolymer having long chain branching obtained by multiplying melt tension at 230° C. with melt flow rate is assumed as M1 (gf·g/10 min.), value of aforesaid propylene ethylene block copolymer obtained by multiplying melt tension at 230° C. with melt flow rate is assumed as M2 (gf·g/10 min.) and value of aforesaid low density polyethylene obtained by multiplying melt tension at 230° C. with melt flow rate is assumed as M3 (gf·g/10 min.), above mentioned W1, W2 and W3 get determined so as to satisfy the below mentioned Eq. 2.

M1×W1/100+M2×W2/100+M3×W3/100≧17 [Eq 2]

Further, when tensile rupture elongation at 23° C. of propylene homopolymer having long chain branching is assumed as E1(%), tensile rupture elongation at 23° C. of propylene ethylene block copolymer is assumed as E2(%) and tensile rupture elongation at 23° C. of low density polyethylene is assumed as E3(%), they get determined so as to satisfy the below mentioned Eq. 3.

E1×W1/100+E2×W2/100+E3×W3/100≧200 [Eq 3]

To be more precise, the mixing ratio of propylene homopolymer having long chain branching, propylene ethylene block copolymer and low density polyethylene in resin is adjusted in such a way that it satisfies above Equations 1, 2 and 3.

After adding the blowing agent to this base resin and mixing inside the extruder, it is stored in the accumulator (not shown in the Fig.) inside the die and after a prescribed amount of resin accumulates, a ring-shaped piston (not shown in the drawings) is pushed down vertically.

Next, it is extruded between split dies 10 as cylindrical parison 9 at the extrusion speed of above 700 Kg/hour through the die slit of extrusion head 8 shown in FIG. 3.

Thereafter, split dies 10 are closed with parison 9 in-between, and air is blown at a rate of 0.05˜0.15 MPa in Parison 9 to form the Roof Side Duct 1.

Further, formation of foam based on blow molding as explained above is not the only method. One can also draw in extruded parison into the die and form the molding of a prescribed shape i.e., by the vacuum molding method. And compression molding method where air is neither blown nor sucked in and extruded parison is held in a die to mold can also be used.

### WORKING EXAMPLES

In the following lines, the exemplary embodiments have been explained based on Working and Comparative examples, but the present invention is not restricted to these examples.

First, propylene homopolymer (PP1, PP2), propylene ethylene block copolymer (PP3) and low density polyethylene (LDPE) used as working and comparative examples are as follows.
PP1: Bolearis Co., Product Name Daploi (WB130)
PP2: Bolearis Co., Product Name Daploi (WB135)
PP3: Japan polypropylene Co. Ltd., Product Name “New Former” (FB 3312)
LDPE: Sumitomo Chemical Co. Ltd., Product Name “Sumikasen” (F108-1)

Further, MT (Melt Tension) at 230° C. (gf), MFR (Melt Flow Rate) at 230° C. (g/10 min.), MT×MFR value (gf·g/10 min.), Tensile Elastic Modulus (MPa) at 23° C. and Tensile Rupture Elongation (%) in these resins have been indicated in Table 1.

Further, MT denotes the tension when melt tension tester (Toyo Precision Machines Ltd.) is used and strand is extruded from orifice 8 mm long, diameter 2.095 mm, extrusion speed 5.7 mm/min., residual heat temp. 230° C. and this strand is wound in roller of 50 mm diameter at a speed of 100 rpm.

Value of MFR is measured in accordance with JIS K-7210 at Test Temp. 230° C., Test Load 2.16 kg.

Moreover, tensile elastic modulus is the value measured with 2 port type test piece in accordance with JIS K7113 at room temp. (23° C.) and pulling speed of 50 mm/min.

Tensile rupture elongation is the value measured at normal temperature (23° C.) in accordance with JIS K-7113.

TABLE 1

| | | | | Tensile | Tensile |
|---|---|---|---|---|---|
| | | | | Elastic | Rupture |
| | MT | MFR | MT × MFR | Modulus | Elongation |
| | (gf) | (g/10 min.) | (gf · g/10 min.) | (MPa) | (%) |
| PP1 | 20.0 | 2.1 | 42 | 2000 | 6 |
| PP2 | 16.1 | 2.1 | 34 | 2000 | 6 |
| PP3 | 4.0 | 5.0 | 20 | 1,600 | 70 |
| LDPE | 5.8 | 1.06 | 6 | 275 | 650 |

### Working Example 1

PP1 60 wt %, PP3 10 wt %, LDPE 30 wt % were mixed and used as the base resin.

Next, to this base resin, super critical state nitrogen was added as blowing agent, 60 wt % talc master batch 1.5 weight parts as nucleophile and 40 wt % carbon black master batch 1.5 weight parts as coloring agent and blown to obtain foaming resin. After mixing it in the extruder, it was stored in accumulator in the die—the cylindrical space between mandrel and die external cylinder and using ring like piston, it was extruded to split die as cylindrical parison and after closing the die, blow molded sample was obtained by blowing air at pressure 0.1 MPa in parison.

### Working Example 2

PP1 40 wt %, PP3 15 wt % and LDPE 45 wt % were mixed and used as the base resin.

Other processes were same as example 1 to obtain the blow molded sample.

### Working Example 3

PP1 45 wt %, PP3 20 wt % and LDPE 35 wt % were mixed and used as the base resin.

Other processes were same as example 1 to obtain the blow molded sample.

### Working Example 4

PP1 30 wt %, PP3 35 wt % and LDPE 35 wt % were mixed and used as the base resin.

Other processes were same as example 1 to obtain the blow molded sample.

### Working Example 5

PP1 20 wt %, PP3 30 wt % and LDPE 50 wt % were mixed and used as the base resin.

Other processes were same as example 1 to obtain the blow molded sample.

### Working Example 6

PP1 20 wt %, PP3 50 wt % and LDPE 30 wt % were mixed and used as the base resin.

Other processes were same as example 1 to obtain the blow molded sample.

### Working Example 7

PP1 40 wt %, PP3 10 wt % and LDPE 50 wt % were mixed and used as the base resin.

Other processes were same as example 1 to obtain the blow molded sample.

### Working Example 8

PP2 60 wt %, PP3 10 wt % and LDPE 30 wt % were mixed and used as the base resin.

Other processes were same as example 1 to obtain the blow molded sample.

### Working Example 9

PP2 40 wt %, PP3 15 wt % and LDPE 45 wt % were mixed and used as the base resin.

Other processes were same as example 1 to obtain the blow molded sample.

### Working Example 10

PP2 45 wt %, PP3 20 wt % and LDPE 35 wt % were mixed and used as the base resin.

8Other processes were same as example 1 to obtain the blow molded sample.

### Working Example 11

PP2 30 wt %, PP3 35 wt % and LDPE 35 wt % were mixed and used as the base resin.

Other processes were same as example 1 to obtain the blow molded sample.

### Working Example 12

PP2 20 wt %, PP3 50 wt % and LDPE 30 wt % were mixed and used as the base resin.

Other processes were same as example 1 to obtain the blow molded sample.

### Working Example 13

PP2 40 wt %, PP3 10 wt % and LDPE 50 wt % were mixed and used as the base resin.

Other processes were same as example 1 to obtain the blow molded sample.

### Comparative Example 1

PP1 20 wt %, PP3 20 wt % and LDPE 60 wt % were mixed and used as the base resin.

Other processes were same as Working Example 1 to obtain the blow molded sample.

### Comparative Example 2

PP1 10 wt %, PP3 50 wt % and LDPE 40 wt % were mixed and used as the base resin.

Other processes were same as Working Example 1 to obtain the blow molded sample.

### Comparative Example 3

PP3 60 wt % and LDPE 40 wt % were mixed and used as the base resin.

Other processes were same as Working Example 1 to obtain the blow molded sample.

### Comparative Example 4

PP1 80 wt % and PP3 20 wt % were mixed and used as the base resin.

Other processes were same as Working Example 1 to obtain the blow molded sample.

### Comparative Example 5

PP1 80 wt % and LDPE 20 wt % were mixed and used as the base resin.

Other processes were same as Working Example 1 to obtain the blow molded sample.

### Comparative Example 6

PP1 70 wt % and LDPE 30 wt % were mixed and used as the base resin.

Other processes were same as Working Example 1 to obtain the blow molded sample.

### Comparative Example 7

PP1 50 wt % and LDPE 50 wt % were mixed and used as the base resin.

Other processes were same as Working Example 1 to obtain the blow molded sample.

### Comparative Example 8

PP1 50 wt % and PP3 50 wt % were mixed and used as the base resin.

Other processes were same as Working Example 1 to obtain the blow molded sample.

### Comparative Example 9

PP2 20 wt %, PP3 20 wt % and LDPE 60 wt % were mixed and used as the base resin.

Other processes were same as Working Example 1 to obtain the blow molded sample.

### Comparative Example 10

PP2 10 wt %, PP3 50 wt % and LDPE 40 wt % were mixed and used as the base resin.

Other processes were same as Working Example 1 to obtain the blow molded sample.

### Comparative Example 11

PP2 80 wt % and PP3 20 wt % were mixed and used as the base resin.

Other processes were same as Working Example 1 to obtain the blow molded sample.

### Comparative Example 12

PP2 80 wt % and LDPE 20 wt % were mixed and used as the base resin.

Other processes were same as Working Example 1 to obtain the blow molded sample.

### Comparative Example 13

PP2 70 wt % and LDPE 30 wt % were mixed and used as the base resin.

Other processes were same as Working Example 1 to obtain the blow molded sample.

### Comparative Example 14

PP2 50 wt % and LDPE 50 wt % were mixed and used as the base resin.

Other processes were same as Working Example 1 to obtain the blow molded sample.

### Comparative Example 15

PP2 50 wt % and PP3 50 wt % were mixed and used as the base resin.

Other processes were same as Working Example 1 to obtain the blow molded sample.

### Comparative Example 16

PP2 20 wt %, PP3 30 wt % and LDPE 50 wt % were mixed and used as the base resin.

Other processes were same as Working Example 1 to obtain the blow molded sample.

Physical properties of Working Examples 1˜13 and Comparative Examples 1˜16 were evaluated as under.

### <Expansion Ratio>

Expansion ratio was calculated by dividing the density of mixed resin used in Working Examples 1˜13 and Comparative Examples 1˜16 with apparent density of the wall of the corresponding foammolding sample.

### <Impact Strength>

Impact strength was computed by first leaving the sample of foammolding in −10° C. constant temp. bath for more than 1 hour and after dropping a 1 Kg metallic ball on the flat part of the said foammolding, when the crack occurred, by measuring the minimum height (cm) of the metallic ball at 10 cm interval and obtaining the product of metallic ball weight 1 Kg and minimum height (cm).

Mixing ratio of PP1, PP2, PP3 and LDPE regarding Working Examples 1˜13 and Comparative Examples 1˜16 and Expansion Ratio and Impact Strength obtained based on above method have been indicated in Table 2.

Further, with regard to each Working Example and Comparative Example, the weight % (W1) of Propylene homopolymer (PP1 or PP2) having long chain branching that constitutes the base resin and MT×MFR value (M1), the weight % (W2) of Propylene ethylene block copolymer (PP3) and value of MT×MFR (M2), weight % (W3) of low density poly ethylene (LDPE) and value of MT×MFR (M3) obtained by substituting on the left side of the above Equation 2 have been indicated.

Moreover, with regard to each Working Example and Comparative Example, weight % (W1) of Propylene homopolymer (PP1 or PP2) having long chain branching that constitutes the base resin, Tensile Rupture Elongation (E1), weight % (W2) of Propylene ethylene block copolymer (PP3) and Tensile Rupture Elongation (E2) and weight % (W3) of low density polyethylene (LDPE) and Tensile Rupture Elongation (E3) obtained by substituting on the left side of above Equation 3 have been indicated.

TABLE 2

| | | | | | Expansion | Impact | | |
|---|---|---|---|---|---|---|---|---|
| | Mixing Ratio | | | | Ratio | Strength | | |
| | PP1 | PP2 | PP3 | LDPE | (Times) | (Kg · cm) | Eq. 2 | Eq. 3 |
| Working Ex. 1 | 60 | 0 | 10 | 30 | 3.9 | 30 | 29.0 | 206 |
| Working Ex. 2 | 40 | 0 | 15 | 45 | 3.1 | 75 | 22.5 | 305 |
| Working Ex. 3 | 45 | 0 | 20 | 35 | 3.3 | 40 | 25.0 | 244 |
| Working Ex. 4 | 30 | 0 | 35 | 35 | 2.9 | 60 | 21.7 | 254 |
| Working Ex. 5 | 20 | 0 | 30 | 50 | 2.1 | 100 | 17.4 | 347 |
| Working Ex. 6 | 20 | 0 | 50 | 30 | 2.7 | 80 | 20.2 | 321 |
| Working Ex. 7 | 40 | 0 | 10 | 50 | 2.9 | 85 | 21.8 | 334 |
| Working Ex. 8 | 0 | 60 | 10 | 30 | 3.2 | 30 | 24.2 | 202 |
| Working Ex. 9 | 0 | 40 | 15 | 45 | 2.6 | 75 | 19.3 | 303 |
| Working Ex. 10 | 0 | 45 | 20 | 35 | 2.8 | 40 | 21.4 | 242 |
| Working Ex. 11 | 0 | 30 | 35 | 35 | 2.6 | 60 | 19.3 | 252 |
| Working Ex. 12 | 0 | 20 | 50 | 30 | 2.4 | 80 | 18.6 | 230 |
| Working Ex. 13 | 0 | 40 | 10 | 50 | 2.5 | 85 | 18.6 | 332 |
| Comparative Ex. 1 | 20 | 0 | 20 | 60 | 1.8 | 150 | 16.0 | 405 |
| Comparative Ex. 2 | 10 | 0 | 50 | 40 | 1.8 | 140 | 16.6 | 294 |
| Comparative Ex. 3 | 0 | 0 | 60 | 40 | 1.4 | 150 | 14.4 | 302 |
| Comparative Ex. 4 | 80 | 0 | 20 | 0 | 5.0 | 10 | 37.6 | 19 |
| Comparative Ex. 5 | 80 | 0 | 0 | 20 | 4.5 | 20 | 34.8 | 135 |
| Comparative Ex. 6 | 70 | 0 | 0 | 30 | 3.0 | 25 | 31.2 | 199 |
| Comparative Ex. 7 | 50 | 0 | 0 | 50 | 1.8 | 90 | 24.0 | 328 |
| Comparative Ex. 8 | 50 | 0 | 50 | 0 | 3.5 | 25 | 31.0 | 38 |
| Comparative Ex. 9 | 0 | 20 | 20 | 60 | 1.6 | 150 | 14.4 | 404 |
| Comparative Ex. 10 | 0 | 10 | 50 | 40 | 1.7 | 140 | 15.8 | 295 |
| Comparative Ex. 11 | 0 | 80 | 20 | 0 | 4.1 | 10 | 31.2 | 14 |
| Comparative Ex. 12 | 0 | 80 | 0 | 20 | 3.6 | 20 | 28.4 | 130 |
| Comparative Ex. 13 | 0 | 70 | 0 | 30 | 2.5 | 25 | 25.6 | 195 |
| Comparative Ex. 14 | 0 | 50 | 0 | 50 | 1.5 | 90 | 20.0 | 325 |
| Comparative Ex. 15 | 0 | 50 | 50 | 0 | 3.0 | 25 | 27.0 | 35 |
| Comparative Ex. 16 | 0 | 20 | 30 | 50 | 1.9 | 100 | 15.8 | 346 |

Samples of Working Examples 1˜13 have Expansion Ratio of above 2.0 times and Impact strength is bigger than 3.0 Kg. cm. Thus, in the method of manufacturing of Working Example, it is possible to make the foammolding which has high Expansion Ratio and good impact resistance.

Further, since low density polyethylene 30-50% is mixed, foaming at low cost is possible.

Here, as for the duct for vehicles, Expansion Ratio of more than 2 times is desirable from weight reduction point of view and impact strength of over 30 Kg. cm is expected.

Therefore, samples of above Working Examples 1˜13 are suitable for duct for vehicles.

Compared to these, samples of Comparative Examples 1, 2, 3, 7, 9, 10, 14, 16 have Expansion Ratio below 2.0 times and in samples and Comparative Examples 4, 5, 6, 8, 11, 12, 13 and 15, Impact strength is below 30 Kg. cm. Thus, in Comparative Examples 1˜16, both Expansion Ratio and Impact strength cannot be improved.

Further, in samples of Working Examples 2, 3, 7, 9, 10 and 13 that have the mixing ratio which satisfies following Eq. 4, since both Expansion Ratio and Impact strength are comparatively higher, they are more suitable for the duct for vehicles.

−0.5×W3+60≦W1≦−0.5×W3+70 [Eq. 4]

To be more precise, samples of Working Examples that satisfy above mentioned Eq. 4 have Expansion Ratio above 2.5 times and Impact strength above 40 Kg. cm. And when compared to Working Examples 1-7 that contain PP1 resin, in Working Example 3, Expansion Ratio is high (3.3 times). And in Working Examples 2 and 7, Impact strength is high (above 75 Kg. cm). Among Working Examples 8-13 that contain PP2 resin, in Working Example 10, Expansion Ratio is high (2.8 times). And in Working Examples 9 and 13, Impact strength is high (75 Kg. cm).

It is preferable than when W1≦−0.5×W3+65 is satisfied.

Samples of Working Examples 2, 7, 9, 13 which satisfy Eq. 4 and contain low density polyethylene above 40 Wt %, are especially suitable for duct for vehicles as they have cheap composition, have high Expansion Ratio and Impact strength.

To be more precise, among Working Examples 1-7 that contain PP1 resin, samples that satisfy above mentioned Eq. 4 and have low density polyethylene above 40 Wt %, Expansion Ratio is more than 2.9 times and Impact Strength is above 75 Kg. cm.

Further, among Working Examples 8-13 containing PP2 resin, samples that satisfy Eq. 4 and low density polyethylene above 40 Wt % have Expansion Ratio above 2-5 times and Impact strength above 75 Kg. cm.

This invention is not confined to light weight air-conditioner duct for vehicles alone. It can be used for automobiles, air crafts, vehicles and ships, construction materials, housing of various electrical machineries, structural elements for sports and leisure etc. If it is used as interior panel of cargo floor board, deck board, rear parcel shelf, roof panel, door trim etc., and automobile structural material like door inner panel, platform, hard top, sun roof, bonnet, bumper, floor spacer, pad etc., it can improve the fuel efficiency as automobile weight can be reduced.

### INDUSTRIAL APPLICATION

Present foammolding is suitable for vehicular air-conditioner duct, especially as thin, light weight roof side duct etc. positioned next to curtain air bag and is expected to have high impact resistance.

Further, above mentioned air-conditioner duct for vehicles contributes to weight reduction of vehicles without any deterioration in the physical properties like mechanical strength.

### EXPLANATION OF CODES/SYMBOLS

1. Roof side duct (Light weight air-conditioner duct for vehicles)
1a. Wall Part
1b. X-X′ Line View Cross Section Diagram
2. Air Supply Port
3. Traverse Duct
4. Body Panel
5. Air Exhaust Port
6. Interior Roof Material
7. Curtain Air Bag
8. Extrusion Pad
9. Parison
10. Split Die
11. Floor Duct (Light weight Air-conditioner duct for vehicles)
12. Closed Part.

What is claimed is:

1. A method for manufacturing molded foam wherein the base resin comprises a mixture of propylene homopolymer having a long chain branch, a propylene ethylene block copolymer and a low density polyethylene, and a blowing agent is mixed to carry outfoaming, wherein: a value obtained by multiplying melt tension at 230° C. with a melt flow rate at 230° C. is above 30 (gf·g/10 minutes);
said propylene ethylene block copolymer comprises a ultrahighmolecular weight polyethylene, and the value obtained by multiplying the melt tension at 230° C. with the melt flow rate at 230° C. is in a range of between 10 (gf·g/10 minutes) and 30 (gf·g/10 minutes); in said base resin, a weight % of propylene homopolymer having long chain branch, is W1 (Wt %), a weight % of said propylene ethylene block copolymer is W2 (Wt %) and a weight % of said low density polyethylene is W3 (Wt %), such that
20≦W1≦60,10≦W2≦50,30≦W3≦50
is satisfied, and further wherein,
a value of said propylene homopolymer having said long chain branch obtained by multiplying said melt tension at 230° C. with said melt flow rate at 230° C. is M1 (gf·g/10 minutes), a value of said propylene ethylene block copolymer obtained by multiplying said melt tension at 230° C. with said melt flow rate at 230° C. is M2 (gf·g/10 minutes) and a value of said low density polyethylene obtained by multiplying said melt tension at 230° C. with said melt flow rate is M3 (gf·g/10 minutes), such that
M1×W1/100+M2×W2/100+M3×W3/100≧17 is satisfied, and further wherein a Tensile Rupture Elongation at 23° C. of said propylene homopolymer having said long chain branch is E1(%), said Tensile Rupture Elongation at 23° C. of said propylene ethylene block Copolymer is E2(%) and said Tensile Rupture Elongation at 23° C. of said low density polyethylene is E3(%), such that E1×W1/100+E2×W2/100+E3×W3/100≦200 is satisfied.

2. The method of manufacturing molded foam in claim 1, wherein
−0.5×W3+60≦W1≦−0.5×W3+70 is satisfied.

3. The method of manufacturing molded foam in claim 2 wherein W3≦40 is satisfied.
